(19) United States
(12) Patent Application Publication
(10) Pub. No.: US 2003/0009588 A1
(43) Pub. Date: Jan. 9, 2003

(54) Resource request forwarding in havi and other internetworking devices

(76) Inventor: Maarten Peter Bodlaender, Eindhoven (NL)

Correspondence Address: Philips Electronics North America Corporation, Corporate Patent Counsel, 580 White Plains Road, Tarrytown, NY, 10591, US

(21) Appl. No.: 10/110,291

(22) PCT Filed: Jul. 26, 2001
(86) PCT No.: PCT/EP01/08658

(30) Foreign Application Priority Data
Aug. 14, 2000 (EP) 00202869.4

(51) Int. Cl. G06F 15/173

(52) U.S. Cl. 709/238

(57) ABSTRACT

The invention relates to a method of switching messages on the basis of matching URL-patterns, and to a device which receives a URL, whereby the device is configured to examine and match the URL on the basis of a regular expression which defines a set of URLs according to specified criteria, whereby if the examined URL matches with one of the defined set, the URL is forwarded to a device which has been registered at the server with the matching definition according to said regular expression. The invention enables that applications running on arbitrary HAVi nodes can access and be accessed without any restrictions. If at least one HAVi device connected to a network has internet access, then any IP-based application can be HAVi-wrapped and be run on any HAVi-box; and any HAVi-application can offer a full web-server and/or web-client functionality; and any HAVi-application can run on any non-HAVi device.

The present invention relates to a method of switching messages between an external network and an internal network, which method comprises the use of an application program interface (API) and/or command protocol hosted by a controlling device. The invention also relates to a functional control module (FCM) and an internetworking device, in particular an home audio video interoperability (HAVi) device, suitable for use with said method.

It is known in the prior art to forward incoming resource requests within a cluster of computers whereby the cluster is connected to one or more networks. To this end the cluster comprises a gateway enabling a host computer outside the cluster to access destination nodes and processes within the cluster. The gateway comprises a message switch which processes incoming and outgoing port-type messages crossing the cluster boundary. Such processing comprises reading a software communication protocol number in a message header in the transport layer, e.g. in the port field in TCP/UDP message headers in order to determine whether it is a port-type message originating from a location outside the cluster. If so, the location of the port number on the message is found and, along with the protocol type, used to search for a match to a port-specific routing function in a table residing in memory within the message switch. If a table entry is matched, a routing function associated with the entry is selected and run. The routing function routes the message to the proper computer node within the cluster by modifying or computing the destination address of the incoming message in order to address the message to the proper node within the cluster.

The described message-switch routing functions well only in a situation in which a user wants to run an application or service that is associated with a specific well-known port number on more than one node. It forms a problem if and when non-standardised port numbers are unknown to internet clients, or when port numbers are unavailable due to being located behind firewalls. Another problem vis-à-vis the prior art relates to forwarding mechanisms themselves: known forwarding mechanisms forward all incoming requests on one port to one address. Since all mechanisms have default port numbers, this means that all requests coming in on the default port are also forwarded to the same address.

It is an object of the present invention to enable applications running on arbitrary nodes to access and to be accessed through a network boundary without all devices in the network having to implement their own proprietary IP-gateways. It is another object of the invention to provide for a method which enables HAVi devices to have access and be accessed across a network boundary without any restrictions. It is a further object to provide for a functional control module (FCM), a device and a system which are suitable for use with such a method.

According to one aspect of the invention one or more of the stated objects are achieved by a method of switching messages according to claim 1.

The basic novel and inventive concept is to base forwarding of a resource request on its matching content, using its URL. In essence, this makes the associated forwarding device an application-level gateway. Matching of information in a URL of an incoming request corresponds to matching to information in both its header and body. A URL can also refer to an exchange of messages. In both situations the related technical advantage is that a simple API and/or command protocol suffices as means for the function of instructing a gateway to commence or stop forwarding incoming requests, in particular when compared to examination of a message header in the transport layer, e.g. in the port field in TCP/UDP message headers.

In regard of a URL referring to an exchange of messages the gateway acts as the recipient of incoming messages and it responds according to the associated protocol until such time that either a match is identified and subsequently the messages can be forwarded, or that no match is identified and subsequently the request is denied.

In a further embodiment, the controlling function comprises an operation of reconstructing or modifying an incoming URL from the request message and forwarding the incompletely or completely reconstructed or modified URL to a responding internal device. This is advantageous in that reconstructed or modified URLs are easier to forward instead of the specific protocol associated with the request, which protocol may be quite complex in some cases. This allows for unsophisticated client devices being able to provide at least bare responses to requests associated with complex protocols. The technical skills required for reconstructing or modifying a string as such are known from the prior art. The URL-matching mechanism can deal with incomplete reconstructed URLs as long as it is ensured that any missing elements of a reconstructed URL satisfy the pattern to be matched against, e.g. by ensuring that the missing elements of the reconstructed URL are matched by wildcards in the REGEXP field of the API and/or command protocol.

In another further embodiment, the controlling function comprises a function of multicasting the incoming requests to a number of devices on the internal network that have addresses which match the incoming URL-pattern. This allows multiple devices to each implement a part of a URL scheme. These devices can share a single port, e.g. the default port. Forwarding on default ports can thus be transparent to a client device.

Still further, the controlling function comprises an operation for processing responses from a number of devices to a forwarded request and for forwarding the URL of the incoming request, or part thereof, to a specific one of the responding internal devices. Any responses to the controlling device can be combined into a single response through the use of a (uploadable) combination function. This offers reliability, since as long as at least one internal device responds, the server function is in operation. It also offers the advantage of aggregation of information, e.g. to provide overviews. It furthermore offers speed since the fastest service available will respond. In case of no response to the controlling device, the resource request actually functions as an information dissemination service.

According to the method, the URL associated with a resource request is encoded in the request in a scheme-specific manner. For HTTP versions, e.g. the host name is not always included in the message, or the request comprises the entire URL unmodified in ASCII in the message. The internet gateway accepts only forwarding requests for schemes for which it can decode the URL from the actual resource request message. When a resource request is received at an internet gateway, this request is forwarded to a forwarding address stored in a table associated with the gateway only if the request-URL matches a URL-pattern corresponding to the stored forwarding address.

It shall be clear that the invention is directed to where a resource request is forwarded and that it is not limitative in regard of how a resource request is forwarded.

According to another aspect of the invention the method of message switching is suitable for use where the incoming request is associated with one of the following: an audio message, a digital image, a video image, an audio-video recording, and a document. Further, the method of message switching is suitable for use where the external network and/or the internal network are/is associated with one of the following: a HAVi device, a personal computer, a network computer, and a web server. This is advantageous in that the HAVi features of interoperability and streaming, extended by full IP-functionality, provide for a suitable carrier for internet access in the home, and thus make HAVi attractive for use with a wide range of home networking devices.

Preferably, a message to be switched is associated with an IP-application. More preferably, a message to be switched is associated with an HAVi-application that is suitable for use with a functional control module (FCM) that offers access to the server side of application-level protocols. This offers the advantages that any (HAVi-) device can have a web-server functionality; that a (HAVi-) device does not require an IP-stack to provide web content; and that a (HAVi-) device does not require its own, unique IP-address.

Preferably, the functional control module that offers access to the server side of application-level protocols is the HAVi-defined web proxy FCM which comprises a web server functionality. If a gateway implements a web server FCM, applications on HAVi-only devices can allow remote access to themselves. Such access to a HAVi home network enables home remote control, live streaming from the home to the internet, serving web pages from the home and other applications that can run on internet servers. Arbitrary browsers on IP-only devices can access these servers, as they would access normal internet servers. A web server FCM allows for fine-grained forwarding of incoming requests.

An alternative is that the functional control module that offers access to the server side of application-level protocols is the HAVi-defined web proxy FCM which comprises a TCP/UDP functionality. This is advantageous in that existing HAVi applications and devices can be left unchanged. Furthermore, IP-only devices are unmodified and interoperable with HAVi applications which make use of a TCP/UDP FCM. A TCP/UDP FCM thus allows HAVi applications to implement any application-layer protocol, allowing access to both the client-side and the server-side of protocols (including emerging peer-to-peer internet protocols.

Together, the known Web proxy FCM and a web server FCM offer full access to a number of application-layer protocols. Both FCMs offer essentially a transport-layer API for a restricted set of application-layer protocols. A TCP/UDP FCM offers full access to transport-layer protocols: it supports any application layer on top of TCP/UDP, it can be used to implement well-known sockets API for easy porting of existing applications, and it offers access to the server-side of client/server protocols.

Another basic thought of the invention is thus to provide any HAVi application unrestricted and full access to an entire (gateway) IP-stack. This enables web FCM with different APIs and/or command protocols to be extended for any associated protocols. In regard of connectionless protocols, all HAVi applications thus share one IP-address. According to the invention, requests are thus multicasted and applications are configured to filter relevant responses and data. Applications are also configured to reserve exclusive access to one or more protocols and to one or more ports. It is also possible to limit an API and/or command protocol according to the invention to connection-based protocols such as TCP.

The invention is also related to an internet gateway device suitable for use with a method of message switching according to the invention, and to a computer programme for putting the invention to practice. Furthermore, the invention is also related to a system such as an internet gateway device, comprising a receiving unit, a forwarding unit and a controlling unit according to claim 14, which system is suitable for implementing the method according to the invention.

These and other aspects of the invention will be apparent from and elucidated with reference to the embodiment(s) described hereinafter.

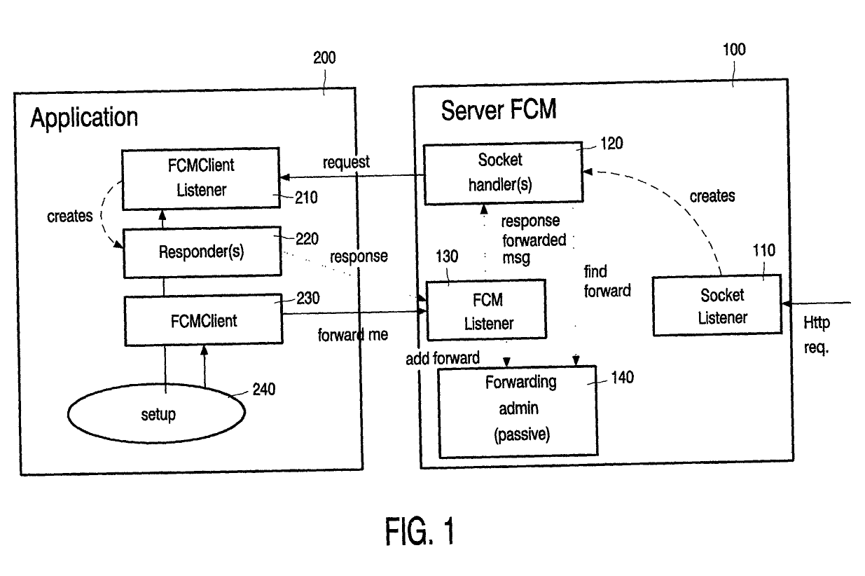

FIG. 1 depicts a general web server set-up suitable for use with the invention;

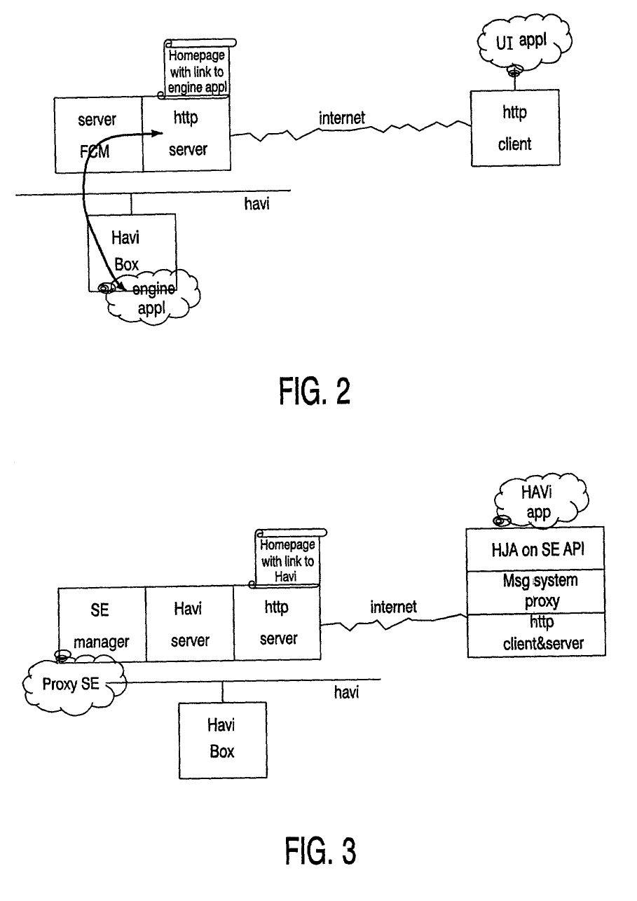

FIG. 2 depicts a schematic lay-out of a web server FCM extension to HAVi;

FIG. 3 depicts a HAViML server (HAViML being a XML-based language suitable for translating the API and/or command control protocol into an existing markup language such as XML or SOAP) added to one side of a gateway and a HAViML client added to an IP device on the other side of the gateway; and

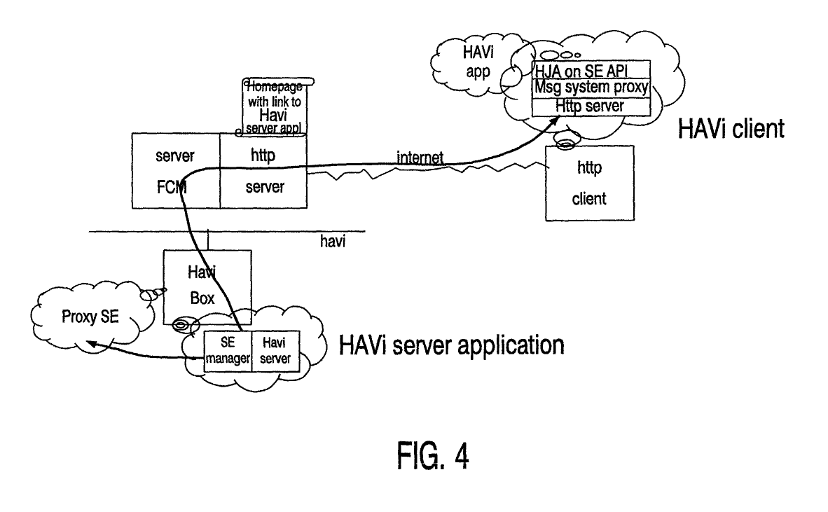

FIG. 4 depicts the use of a combination of HAViML and a HAVi web server FCM.

According to an embodiment of the invention, the general setup of which is shown schematically in FIG. 1, there are two blocks, a server FCM 100 and an application 200, which form an internet gateway. The server FCM block 100 comprises a socket listening device 110, one or more socket handling devices 120, a FCM listening device 130 and a forwarding administration device 140. The application block 200 comprises a FCM Client listening device 210, one or more responding devices 220, a FCM Client device 230 and a setup device 240. During operation, an incoming request, e.g. a HTTP request is picked up by the socket listening device 110 and sent on to a socket handling device 120. The socket handling device 120 matches an URL-pattern to the forwarding addresses stored through the forwarding administration device 140. The FCM listening device 130 adds in a forwarding code, and the socket handling device 120 multicasts the request to the FCM Client listening device 210. The setup 240 of the application block 200 allows for one or more FCM client devices 230 to respond to the multicasted request; responding client devices send a code to the FCM listening device 130 on the server FCM block 100 and another code to a responding device 220 on the application block 200. The responding device 220 also sends a code to the FCM listening device 130 on the server FCM block and the latter 130 sends the responses coming from the application block to the socket handling block 120. The socket handling block 120 then forwards the incoming requests to only the FCM client devices 230 which have listed URL-patterns that match with URL-patterns of the incoming messages. Finally, the socket handling device 120 forwards the responses of the application block 200 to the client on the internet that issued the request.

A gateway device embodying the controlling function can thus e.g. receive three messages, buffer these messages, execute the matching operation and then forward the messages to different addresses within the network. A single request, of course, can also comprise several messages. Thus it allows for several devices within the internal network to wait concurrently for incoming requests directed to a single port.

In regard of the aspect of sharing a web server functionality between several devices: it is thus possible that device A covers for “mysite.com/*.wmp” and device B covers for “mysite.com/*.txt”, etc. As to the matching operation: a gateway avails of a list of regular expressions, instead of e.g. hash values. For example, incoming messages comprising “give all requests for *.txt”, “all streaming requests”, and “subdirectory X” can be matched with the listed regular expressions. This may require translation to protocols as the URLs may need to be reconstructed and forwarded to the appropriate server. Devices connected to the server side of the gateway need to instruct or configure the gateway by providing for regular expressions for the list. Also caches of individual resources may need to be configured on the server side.

FIG. 2 provides a schematic lay-out of a web server FCM extension to HAVi. This example serves to illustrate the point that any HAVi application can offer a full web server functionality. A server FCM is associated with a http server hosting a homepage whereby the homepage has a link to an engine application. The web server FCM and the http server are associated with a remote HAVi network comprising one or more HAVi boxes, and they form an internet gateway to one or more http clients. A user interface application serves the client side of the gateway and an engine application serves the internal device (e.g. HAVi device) side of the gateway. In combination, the user interface application and the engine application enable implementation of a distributed application on the internal (HAVi) device side of the gateway. There are two points to consider in relation to this setup. The first point is that an application subscribes to a port/sub-directory and an associated protocol. An example hereof is:

ServerProxy::ServeMe (8080, ‘FTP’)

ServerProxy::ServeMe (8080, ‘www.bodlaender.home/tivo’, ‘HTTP’)

The second point to consider is that an internet browser can push towards the application. E.g.

<A HREF=‘www.bodlaender.home/tivo?password=131255>check tivo</a>

FIG. 3 depicts a HAViML server (HAViML being a XML-based language suitable for translating the API and/or command control protocol into an existing markup language such as XML or SOAP) added to one side of a gateway and a HAViML client added to an IP device on the other side of the gateway. This example serves to illustrate the point that HAVi applications can run on any non-HAVi device. A HAViML server is associated with a http server hosting a homepage whereby the homepage has a link to the HAViML. There is also a SE manager associated with the HAViML server and one or more remote internal HAVi devices are represented in a HAVi network by a proxy SE. The http server forms part of an internet gateway to one or more http clients. A HAVi application serves the client side of the gateway, covering a HJA on a SE API and/or command control, a message system proxy and a http client & server. There are a number of points to consider in relation to this setup. First, an entire remote stack can be downloaded from an index page. Second, a remote device can fully avail of any HAVi application. Third, this setup does require some stacking on the client side of the gateway. HAViML (as defined above) is quite suitable for allowing unmodified HAVi applications to run on IP devices. There are a couple of disadvantages to HAViML: one relates to a security risk, and another to its being a proprietary solution. HAViML is appropriate for use when offering full access to a HAVi home network is not always required and when somewhat restricted forms of access are preferable.

FIG. 4 depicts the use of a combination of HAViML and a HAVi web server FCM. This is to illustrate the point that a HAViML can be a HAVi application which makes use of a server FCM. A server FCM is associated with a http server hosting a homepage whereby the homepage has a link to a HAViML server application. The server FCM and the http server are associated with a remote HAVi network comprising one or more HAVi boxes, and they form an internet gateway to one or more http clients. There is also a SE manager associated with the HAViML server, as well as a proxy SE. One or more remote internal HAVi devices are represented in a HAVi network by the proxy SE. The http server forms part of an internet gateway to one or more http clients. A HAVi application serves the client side of the gateway and covers a HJA on a SE API and/or command protocol, a message system proxy and a http server which are separated from the http client. There are two points to consider in relation to this setup. First, the HAViML server application associates with the message system proxy and the SE manager. Second, the HAViML client associates with the message system proxy, the SE API and or command protocol, the HJA and the HJA application.

In this embodiment traffic across the gateway can comprise the following exchanges:

(on HAVi device):

ServerProxy::ServeMe (‘www.bodlaender.home/HPAViML’, ‘HTTP’)

(on HTTP client device):

retrieve ‘www.bodlaender.home’ webpage, with the following link:

<A HREF=‘www.bodlaender.home/HAViML?application=demoapp>demo HAViML</a>

(on server FCM, after the request):

forward ‘application=demoapp’ to HAVi box

(on HAVi box):

reply with HAViML applet ‘demoapp’

(on client device):

run applet, start normal HAViML application

The aspect of the invention which relates to forwarding of a resource request based on its matching content, using its URL, is illustrated by way of the following example. The actors are: internet client C, internet gateway device G, and home networking clients H1 and H2. The steps to follow are:

step 1:
G obtains an internet connection, DNS name “Philips.com”

(sharing mail server)

step 2:
H1 requests forwarding of the mail protocol from G:

ForwardingToStart (“mailto: *Bodlaender*”, H1_address) : registration handle

H2 requests forwarding of the mail protocol from G:

ForwardingToStart (“mailto: *Gravendeel*”, H2_address) : registration handle

step 3:
C sends a mail message “mailto: Maarten.Bodlaender@Philips.com”
step 4:
G receives the mail message, decodes the message's URL and finds a match of the message's URL to H1's pattern
G forwards the mail message to H1
step 5:
H1 receives the mail message
(sharing HTTP server)
step 6:
H1 requests forwarding of the HTTP protocol from G:

ForwardingToStart (“HTTP://H1/*”,H1_address) : registration handle

H2 requests forwarding of the HTTP protocol from G:

ForwardingToStart (“HTTP://H2/*”,H2_address) : registration handle

step 7:
C requests a web page http://www.philips.com/H2/index.html
step 8:
G receives the request of step 7, decodes the message's URL and finds a match of the message's URL to H2's pattern
G forwards the requestmessage to H2
step 9:

H2 receives the request, and returns a response to G

step 10:
G forwards the response back to C

An embodiment of an application program interface for a HAVi server FCM comprises the following on the server side of a gateway connection:

ServerProxy:: ServeMe(

| in ProtocolType protocol, | |
|---|---|
| in uint portNumber, | //if 0: default for protocol, or any available |
| in OperationCode opCode, | //call-back method that implements server |

in short myBufferSize,
out short proxyBufferSize
out uint assignedPortNumber)

ServerProxy:: DontServeMe(

in uint assigned PortNumber)

<Client>::OpenRequest(

| | |
|---|---|
| in long cid, | //unique identifier for each concurrent request |
| out OperationCode opCode, | //call-back method (specific Message Handler) |

<Client>::Receive(

| | |
|---|---|
| in long cid, | //unique identifier for each concurrent request |
| in FileLoc where, | |

in sequence<octet> webData)//contains part of a REQUEST

ServerProxy::Send(

in long cid,
in FileLoc where,
in sequence<octet> webData)//contains part of a RESPONSE

<Client::CloseRequest(

in long cid)

Another embodiment of an application program interface for a HAVi server FCM comprises the following on the client-side of a gateway connection:

ServerProxyClient:: ServeMe(

in String prefix,
in short myBufferSize,
out short proxyBufferSize
out uint assignedPortNumber)

ServerProxyClient::DontServeMe(

in uint assigned PortNumber)

ServerProxyClient::Send(

| in long cid, | |
|---|---|
| in FileLoc where, | |
| in sequence<octet> webData) | //contains part of a RESPONSE |

Client Listener implements the following to receive requests:
<Client>::Receive(

| | |
|---|---|
| in long cid, | //unique identifier for each concurrent request |
| in FileLoc where, | |

| | in sequence<octet> webData)// contains part of a REQUEST | |
|---|---|---|
| where | =FIRST/direct END | :setup admin on cid, start buffering request (MIDDLE) |
| | = END | :fork responder: SEND (cid) |

Yet another embodiment of an application program interface for a HAVi server FCM comprises the following on the client-side of a gateway connection:

ServerProxyClient:: ServeMe(

in String REGEXP,
in short myBufferSize,
out short proxyBufferSize
out uint assignedPortNumber)

ServerProxyClient::DontServeMe(

in uint assigned PortNumber)

ServerProxyClient::Send(

| in long cid, | |
|---|---|
| in FileLoc where, | |
| in sequence<octet> webData) | //contains part of a RESPONSE |

Client Listener implements the following to receive requests:
<Client>::Receive(

| | in long cid, | //unique identifier for each concurrent request |
|---|---|---|
| | in FileLoc where, | |
| | in sequence<octet> webData) | // contains part of a REQUEST |
| where | =FIRST/direct END | : setup admin on cid, start buffering request (MIDDLE) |
| | =END | : fork responder: SEND (cid) |

Finally, the invention also extends to computer programmes, in particular to computer programmes on or in a carrier, adapted for putting the invention into practice. The programme may be in the form of source code, object code, a code intermediate source and object code such as in partially compiled form, or in any other form suitable for use in the implementation of the processes according to the invention. The carrier may be any entity or device capable of carrying the programme. For example, the carrier may comprise a storage medium or it may be a transmissible carrier such as an electrical or optical signal which may be conveyed via electrical or optical cable or by radio or by other means. When the programme is embodied in a signal which may be conveyed directly by a cable or other device or means, the carrier may be constituted by such cable or other device means. Alternatively, the carrier may be an integrated circuit in which the programme is embedded, the integrated circuit being adapted for performing, or for use in the programme, of the relevant process steps.

The general novel and inventive concept described above enables applications running on arbitrary HAVi nodes to access and to be accessed by internetworking without any restrictions. If at least one HAVi device connected to a network has internet access, then any IP-based application can be HAVi-wrapped and be run on any HAVi-box; and any HAVi-application can run a full web-server and/or web-client functionality; and any HAVi-application can run on any non-HAVi device.

1. A method of switching messages between an external network and an internal network, which method comprises the use of an application program interface (API) and/or command protocol hosted by a controlling device, which API and/or command protocol comprises a function of controlling forwarding of a request, which request comprises a Universal Resource Locator (URL), coming from a device of the external network to an address associated with a device of the internal network, whereby the function comprises the following operations:
a) ForwardingtoAdd (URL-pattern, forwarding address): registration handle; whereby the URL-pattern is a regular expression, and the forwarding address is a network address such as an IP-address or a HAVi-address or a local process address, such that during use the URL-pattern and forwarding address are storable in the internal state of the controlling device; and
b) ForwardingtoStop (URL-pattern, forwarding address); such that during use the URL-pattern and forwarding address comprised in the registration handle are removable from the internal state of the controlling device; as the basis for switching an incoming message to the device of the internal network.

2. A method of message switching according to claim 1, whereby the controlling function comprises an operation of reconstructing or modifying an incoming URL from the request message and forwarding the incompletely or completely reconstructed or modified URL, to a responding internal device.

3. A method of message switching according to claim 1 or claim 2, whereby the controlling function comprises a function of multicasting the incoming requests to a number of devices on the internal network that have addresses which match the incoming URL-pattern.

4. A method of message switching according to claim 3, whereby the controlling function comprises an operation for processing responses from a number of devices to a forwarded request and for forwarding the URL of the incoming request, or part thereof, to a specific one of the responding internal devices.

5. A method of message switching according to any of claims 1-4, suitable for use where the incoming request is associated with one of the following:
an audio message, a digital image, a video image, an audio-video recording, and a document.

6. A method of message switching according to any of claims 1-4, suitable for use where the external network and/or the internal network are/is associated with one of the following:
a HAVi device, a personal computer, a network computer, and a web server.

7. A method of message switching according to claim 6, whereby the message to be switched is associated with an IP-application.

8. A method of message switching according to claim 6, whereby the message to be switched is associated with an HAVi-application that is suitable for use with a functional control module (FCM) that offers access to the server side of application-level protocols.

9. A functional control module (FCM) suitable for use with a method of switching according to claim 8, whereby the FCM is the HAVi web proxy FCM comprising a web server functionality.

10. A functional control module (FCM) suitable for use with a method of switching according to claim 8, whereby the FCM is the HAVi web proxy FCM comprising a TCP/UDP functionality.

11. An internet gateway device suitable for use with a method of message switching according to any of claims 1-10.

12. A computer programme comprising instructions, which instructions include at least code defining the processes or functions to be performed with respect to examining and matching codes and address-redirections associated with said matching codes, for causing a programmable processing apparatus having or being connected to transmission hardware to become operable to execute the ForwardingtoAdd and ForwardingtoStop operations of the method of message switching according to any of claims 1-8.

13. Transmission entity of which a computer programme according to claim 12 forms a component.

14. A system such as an internet gateway device, comprising:
a receiving unit for receiving an incoming request, which request comprises a Universal Resource Locator (URL), from an external network;
a forwarding unit for forwarding a URL or part thereof to one of a number of devices connected to the system via an internal network; and
a controlling unit that is suitable for use with an application program interface (API) and/or command protocol, which API and/or command protocol comprises a function of controlling the forwarding of the incoming request, whereby the function comprises the following operations:
a) ForwardingtoAdd (URL-pattern, forwarding address): registration handle; whereby the URL-pattern is a regular expression, and the forwarding address is a network address such as an IP-address or a HAVi-address or a local process address, such that during use the URL-pattern and forwarding address are storable in the internal state of the controlling unit; and
b) ForwardingtoStop (URL-pattern, forwarding address); such that during use the URL-pattern and forwarding address comprised in the registration handle are removable from the internal state of the controlling unit; whereby the receiving and forwarding units are controlled by the controlling unit on the basis of said API and/or command protocol functional operations.
